(19) United States
(12) Patent Application Publication
(10) Pub. No.: US 2021/0319691 A1
(43) Pub. Date: Oct. 14, 2021

(54) COLLABORATIVE DETECTION AND AVOIDANCE OF PHANTOM TRAFFIC JAMS

(71) Applicants: Arvind Merwaday, Beaverton, OR (US); Kathiravetpiilai Sivanesan, Portland, OR (US); Satish Chandra Jha, Portland, OR (US); Vesh Raj Sharma Banjade, Portland, OR (US); S M iftekharu! Aiam, Hillsboro, OR (US); Suman A. Sehra, Folsom, CA (US); Leonardo Gomes Baltar, Munchen (DE)

(72) Inventors: Arvind Merwaday, Beaverton, OR (US); Kathiravetpiilai Sivanesan, Portland, OR (US); Satish Chandra Jha, Portland, OR (US); Vesh Raj Sharma Banjade, Portland, OR (US); S M iftekharu! Aiam, Hillsboro, OR (US); Suman A. Sehra, Folsom, CA (US); Leonardo Gomes Baltar, Munchen (DE)

(21) Appl. No.: 17/358,671

(22) Filed: Jun. 25, 2021

(51) Int. Cl. G08G 1/01; G08G 1/0967; G08G 1/052; G08G 1/04

(52) U.S. Cl. CPC G08G 1/0112; G08G 1/0145; G08G 1/096775; G08G 1/04; G08G 1/0116; G08G 1/052; G08G 1/096783; G08G 1/0141

(57) ABSTRACT

Systems and techniques for collaborative detection and avoidance of phantom traffic jams are described herein. Sensor data for a segment of a roadway and vehicle communication data for vehicles travelling on the segment may be obtained. A vehicle density may be calculated for the segment using the sensor data and the vehicle communication data. The sensor data and the vehicle communication data may be monitored for a traffic perturbation based on the calculated vehicle density. A mitigation instruction may be selected for the traffic perturbation upon detection of the traffic perturbation. The mitigation instruction may be transmitted to a vehicle or group of vehicles traveling on the roadway. In an example where infrastructure support is available, it may be determined that a roadside communication device is not available and a first vehicle may transmit a decentralized environmental notification message to a second vehicle

### TECHNICAL FIELD

Embodiments described herein generally relate to autonomous and semi-autonomous vehicle coordination and, in some embodiments, more specifically to collaborative detection and avoidance of phantom traffic jams.

### BACKGROUND

Vehicle traffic jams or congestion is a major problem in urban cities and has significant economic implications. In the United States in 2018, traffic congestion amounted to roughly $87 billion in costs. A phantom traffic jam is a phenomenon that occurs without the existence of a physical bottleneck and typically occurs in highways under moderate to high traffic density. When the traffic density is high enough in the highway, synchronized flow of vehicles takes place in which minor perturbations, like braking by a vehicle, are amplified into a wave of stop-and-go traffic. The perturbation is propagated mainly due to the reaction time of human drivers and failure of drivers to maintain adequate following distances. Phantom traffic jams may be mitigated via coordinated maneuvering of vehicles to dampen the propagation of perturbations in the early stages of the event before it evolves into a stop-and-go traffic jam. Early detection may be desired to enable effective mitigation of perturbations.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an overview of an edge cloud configuration for edge computing.

FIG. 2 illustrates a compute and communication use case involving mobile access to applications in an edge computing system.

FIG. 3A provides an overview of example components for compute deployed at a compute node in an edge computing system.

FIG. 3B provides a further overview of example components within a computing device in an edge computing system.

FIG. 4 is a block diagram of an example of a system for collaborative detection and avoidance of phantom traffic jams, according to an embodiment.

FIG. 5 illustrates an example of a distributed multi-access edge computing architecture with a backhaul data network for collaborative detection and avoidance of phantom traffic jams, according to an embodiment.

FIG. 6 is a data flow diagram of an example perturbation detection and mitigation process for collaborative detection and avoidance of phantom traffic jams, according to an embodiment.

FIG. 7 is a block diagram of an example of an environment perception architecture in a multi-access edge computing network for collaborative detection and avoidance of phantom traffic jams, according to an embodiment.

FIG. 8 illustrates an example of a of spike in vehicle density resulting from a perturbation.

FIG. 9 illustrates an example of multi-hop vehicle-to-vehicle communications-based phantom jam mitigation for collaborative detection and avoidance of phantom traffic jams, according to an embodiment.

FIG. 10 is a flow diagram of an example of a process for vehicle-to-vehicle communications-based phantom jam mitigation mechanism for collaborative detection and avoidance of phantom traffic jams, according to an embodiment.

FIG. 11 is a block diagram of an example of a maneuver coordination message format and structure for collaborative detection and avoidance of phantom traffic jams, according to an embodiment.

FIG. 12 illustrates an example of a method for collaborative detection and avoidance of phantom traffic jams, according to an embodiment.

FIG. 13 illustrates an example of a method for collaborative detection and avoidance of phantom traffic jams, according to an embodiment.

### DETAILED DESCRIPTION

A phantom traffic jam is a phenomenon that occurs without the existence of a physical bottleneck and typically occurs in highways under moderate to high traffic density. When the traffic density is high enough in the highway, synchronized flow of vehicles takes place in which minor perturbations, like braking by a vehicle, are amplified into a wave of stop-and-go traffic. The systems and techniques discussed herein include an infrastructure-based solution to mitigate phantom traffic jams efficiently by leveraging on the road-side sensors, a multi-access edge computing (MEC) platform, and vehicle-to-everything (V2X) communications. Infrastructure-based sensors including, by way of example and not limitation, cameras, light detection and ranging (LIDAR), etc., placed along the highway may provide reliable, live, and detailed information on the status of traffic flow. Broadcast messages like a basic safety message (BSM), a cooperative perception message (CPM), a maneuver coordination message (MCM), a decentralized environmental notification message (DENM), etc., may be received from connected and autonomous vehicles (CAVs) and may provide localized traffic information. These sensor information may be streamed to the MEC where phantom jam detection algorithms analyze the dynamics of traffic in real time and identify perturbations that may lead to phantom jams. The resulting output from phantom jam detection algorithm is used to generate an MCM and transmit the MCM to connected vehicles (CVs) to mitigate phantom jams. The MCMs may contain high level instructions like recommended speed, intervehicle distances, etc. based on overall vehicle density and flowrate. The MCMs may also contain specific trajectories to an individual CAV or a group of CAVs to help dampen the perturbations.

Conventional techniques for phantom jam detection and mitigation techniques may use vehicle-to-vehicle (V2V) communications. In the conventional V2V approach, a following vehicle receives information about the preceding vehicles using their periodically broadcasted BSMs. However, the conventional V2V communications-based approach may have limited effectiveness in mixed traffic scenarios with low penetration of connected vehicles that may include traditional vehicles without V2V connectivity. In addition, the range of detection and mitigation is limited to the range of V2V communications which may be a few hundred meters.

Other conventional approaches to phantom traffic jam mitigation use infrastructure sensors like induction loops to estimate vehicle density and flowrate, which are then used to generate and communicate recommended speed limits to avoid phantom traffic jams. Infrastructure sensors like induction loops are passive and macroscopic in nature which only gives general driving advisory to vehicles and cannot proactively detect and mitigate phantom jams.

The systems and techniques discussed herein provide a proactive solution that actively detects and mitigates perturbations in early stages and avoids potential evolution to stop-and-go traffic. Unlike conventional V2V communications-based approaches, the systems and techniques discussed herein reckon with all vehicle types (e.g., with or without V2X connectivity) via infrastructure sensors.

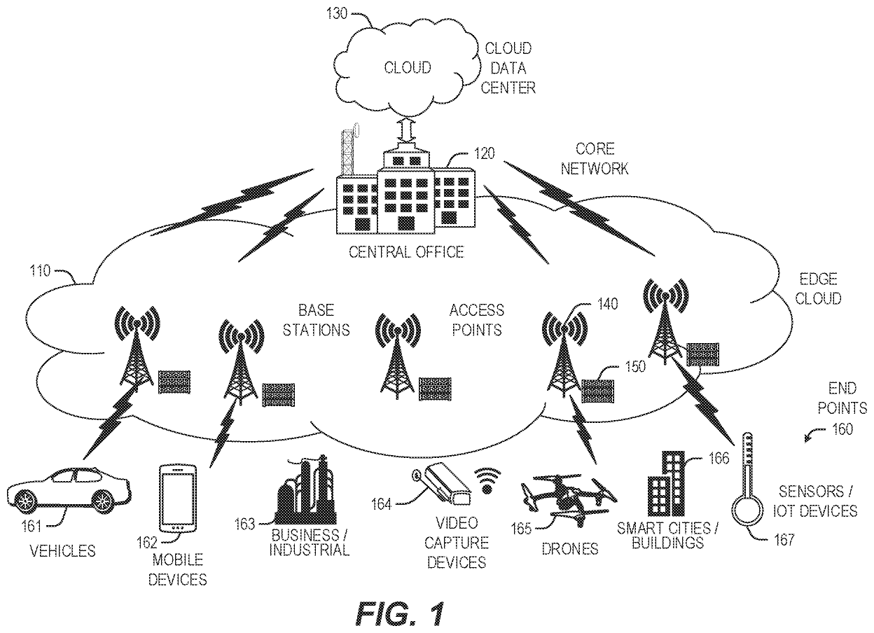

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

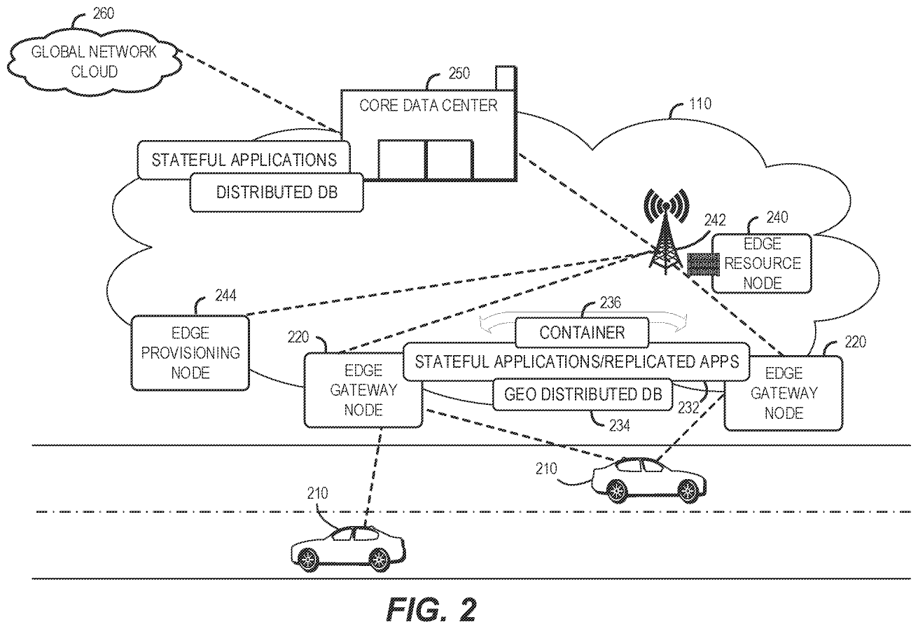

FIG. 2 shows a simplified vehicle compute and communication use case involving mobile access to applications in an edge computing system 200 that implements an edge cloud 110. In this use case, respective client compute nodes 210 may be embodied as in-vehicle compute systems (e.g., in-vehicle navigation and/or infotainment systems) located in corresponding vehicles which communicate with the edge gateway nodes 220 during traversal of a roadway. For instance, the edge gateway nodes 220 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 210 and a particular edge gateway device 220 may propagate so as to maintain a consistent connection and context for the client compute node 210. Likewise, mobile edge nodes may aggregate at the high priority services or according to the throughput or latency resolution requirements for the underlying service(s) (e.g., in the case of drones). The respective edge gateway devices 220 include an amount of processing and storage capabilities and, as such, some processing and/or storage of data for the client compute nodes 210 may be performed on one or more of the edge gateway devices 220.

The edge gateway devices 220 may communicate with one or more edge resource nodes 240, which are illustratively embodied as compute servers, appliances or components located at or in a communication base station 242 (e.g., a based station of a cellular network). As discussed above, the respective edge resource nodes 240 include an amount of processing and storage capabilities and, as such, some processing and/or storage of data for the client compute nodes 210 may be performed on the edge resource node 240. For example, the processing of data that is less urgent or important may be performed by the edge resource node 240, while the processing of data that is of a higher urgency or importance may be performed by the edge gateway devices 220 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 240 also communicate with the core data center 250, which may include compute servers, appliances, and/or other components located in a central location (e.g., a central office of a cellular communication network). The core data center 250 may provide a gateway to the global network cloud 260 (e.g., the Internet) for the edge cloud 110 operations formed by the edge resource node(s) 240 and the edge gateway devices 220. Additionally, in some examples, the core data center 250 may include an amount of processing and storage capabilities and, as such, some processing and/or storage of data for the client compute devices may be performed on the core data center 250 (e.g., processing of low urgency or importance, or high complexity).

The edge gateway nodes 220 or the edge resource nodes 240 may offer the use of stateful applications 232 and a geographic distributed database 234. Although the applications 232 and database 234 are illustrated as being horizontally distributed at a layer of the edge cloud 110, it will be understood that resources, services, or other components of the application may be vertically distributed throughout the edge cloud (including, part of the application executed at the client compute node 210, other parts at the edge gateway nodes 220 or the edge resource nodes 240, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 236 (or pod of containers) may be flexibly migrated from an edge node 220 to other edge nodes (e.g., 220, 640, etc.) such that the container with an application and workload does not need to be reconstituted, re-compiled, re-interpreted in order for migration to work. However, in such settings, there may be some remedial or “swizzling” translation operations applied. For example, the physical hardware at node 240 may differ from edge gateway node 220 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 2 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars. (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 220, some others at the edge resource node 240, and others in the core data center 250 or global network cloud 260.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

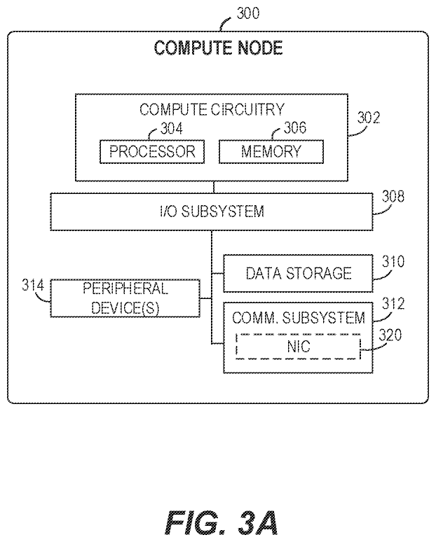

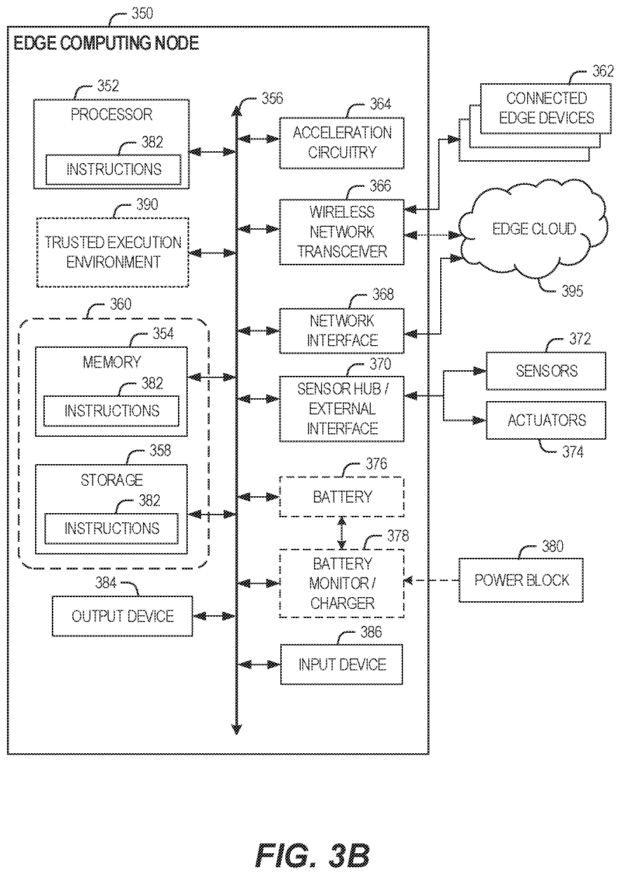

The edge computing system 200 can include or be in communication with an edge provisioning node 244. The edge provisioning node 244 can distribute software such as the example computer readable instructions 382 of FIG. 3B, to various receiving parties for implementing any of the methods described herein. The example edge provisioning node 244 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 244 may be located in a cloud, in a local area network, in an edge network, in a wide area network, on the Internet. and/or any other location communicatively coupled with the receiving party(ies). The receiving parties may be customers, clients, associates, users, etc. of the entity owning and/or operating the edge provisioning node 244. For example, the entity that owns and/or operates the edge provisioning node 244 may be a developer, a seller, and/or a licensor (or a customer and/or consumer thereof) of software instructions such as the example computer readable instructions 382 of FIG. 3B. The receiving parties may be consumers, service providers, users, retailers, OEMs, etc., who purchase and/or license the software instructions for use and/or re-sale and/or sub-licensing.

In an example, edge provisioning node 244 includes one or more servers and one or more storage devices. The storage devices host computer readable instructions such as the example computer readable instructions 382 of FIG. 3B, as described below. Similarly to edge gateway devices 220 described above, the one or more servers of the edge provisioning node 244 are in communication with a base station 242 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 382 from the edge provisioning node 244. For example, the software instructions, which may correspond to the example computer readable instructions 382 of FIG. 3B, may be downloaded to the example processor platform/s, which is to execute the computer readable instructions 382 to implement the methods described herein.

In some examples, the processor platform(s) that execute the computer readable instructions 382 can be physically located in different geographic locations, legal jurisdictions, etc. In some examples, one or more servers of the edge provisioning node 244 periodically offer, transmit, and/or force updates to the software instructions (e.g., the example computer readable instructions 382 of FIG. 3B) to ensure improvements, patches, updates. etc. are distributed and applied to the software instructions implemented at the end user devices. In some examples, different components of the computer readable instructions 382 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 3A and 3B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 3A, an edge compute node 300 includes a compute engine (also referred to herein as “compute circuitry”) 302, an input/output (I/O) subsystem 308, data storage 310, a communication circuitry subsystem 312, and, optionally, one or more peripheral devices 314. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 300 may be embodied as any type of engine, device, or collection of devices capable of performing various compute functions. In some examples, the compute node 300 may be embodied as a single device such as an integrated circuit, an embedded system, a field-programmable gate array (FPGA), a system-on-a-chip (SOC), or other integrated system or device. In the illustrative example, the compute node 300 includes or is embodied as a processor 304 and a memory 306. The processor 304 may be embodied as any type of processor capable of performing the functions described herein (e.g., executing an application). For example, the processor 304 may be embodied as a multi-core processor(s), a microcontroller, a processing unit, a specialized or special purpose processing unit, or other processor or processing/controlling circuit.

In some examples, the processor 304 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 304 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNiC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 304 may work in coordination with each other to execute many types of operations and instructions within and on behalf of the compute node 300.

The memory 306 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 306 may be integrated into the processor 304. The memory 306 may store various software and data used during operation such as one or more applications, data operated on by the application(s), libraries, and drivers.

The compute circuitry 302 is communicatively coupled to other components of the compute node 300 via the I/O subsystem 308, which may be embodied as circuitry and/or components to facilitate input/output operations with the compute circuitry 302 (e.g., with the processor 304 and/or the main memory 306) and other components of the compute circuitry 302. For example, the I/O subsystem 308 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 308 may form a portion of a system-on-a-chip (SoC) and be incorporated, along with one or more of the processor 304, the memory 306, and other components of the compute circuitry 302, into the compute circuitry 302.

The one or more illustrative data storage devices 310 may be embodied as any type of devices configured for short-term or long-term storage of data such as, for example, memory devices and circuits, memory cards, hard disk drives, solid-state drives, or other data storage devices. Individual data storage devices 310 may include a system partition that stores data and firmware code for the data storage device 310. Individual data storage devices 310 may also include one or more operating system partitions that store data files and executables for operating systems depending on, for example, the type of compute node 300.

The communication circuitry 312 may be embodied as any communication circuit, device, or collection thereof, capable of enabling communications over a network between the compute circuitry 302 and another compute device (e.g., an edge gateway of an implementing edge computing system). The communication circuitry 312 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 312 includes a network interface controller (NIC) 320, which may also be referred to as a host fabric interface (HFI). The NIC 320 may be embodied as one or more add-in-boards, daughter cards, network interface cards, controller chips, chipsets, or other devices that may be used by the compute node 300 to connect with another compute device (e.g., an edge gateway node). In some examples, the NIC 320 may be embodied as part of a system-on-a-chip (SoC) that includes one or more processors, or included on a multichip package that also contains one or more processors. In some examples, the NIC 320 may include a local processor (not shown) and/or a local memory (not shown) that are both local to the NIC 320. In such examples, the local processor of the NIC 320 may be capable of performing one or more of the functions of the compute circuitry 302 described herein. Additionally, or alternatively, in such examples, the local memory of the NIC 320 may be integrated into one or more components of the client compute node at the board level, socket level, chip level, and/or other levels.

Additionally, in some examples, a respective compute node 300 may include one or more peripheral devices 314. Such peripheral devices 314 may include any type of peripheral device found in a compute device or server such as audio input devices, a display, other input/output devices, interface devices, and/or other peripheral devices, depending on the particular type of the compute node 300. In further examples, the compute node 300 may be embodied by a respective edge compute node (whether a client, gateway, or aggregation node) in an edge computing system or like forms of appliances, computers, subsystems, circuitry, or other components.

In a more detailed example, FIG. 3B illustrates a block diagram of an example of components that may be present in an edge computing node 350 for implementing the techniques (e.g., operations, processes, methods, and methodologies) described herein. This edge computing node 350 provides a closer view of the respective components of node 300 when implemented as or as part of a computing device (e.g., as a mobile device, a base station, server, gateway, etc.). The edge computing node 350 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 350, or as components otherwise incorporated within a chassis of a larger system.

The edge computing device 350 may include processing circuitry in the form of a processor 352, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 352 may be a part of a system on a chip (SoC) in which the processor 352 and other components are formed into a single integrated circuit, or a single package, such as the Edison™ or Galileo™ SoC boards from Intel Corporation, Santa Clara, Calif. As an example, the processor 352 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif. a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies. Inc., or an OMAP™ processor from Texas Instruments, Inc. The processor 352 and accompanying circuitry may be provided in a single socket form factor, multiple socket form factor, or a variety of other formats, including in limited hardware configurations or configurations that include fewer than all elements shown in FIG. 3B.

The processor 352 may communicate with a system memory 354 over an interconnect 356 (e.g., a bus). Any number of memory devices may be used to provide for a given amount of system memory. As examples, the memory 354 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 358 may also couple to the processor 352 via the interconnect 356. In an example, the storage 358 may be implemented via a solid-state disk drive (SSDD). Other devices that may be used for the storage 358 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory. NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 358 may be on-die memory or registers associated with the processor 352. However, in some examples, the storage 358 may be implemented using a micro hard disk drive (HDD). Further, any number of new technologies may be used for the storage 358 in addition to, or instead of, the technologies described, such resistance change memories, phase change memories, holographic memories, or chemical memories, among others.

The components may communicate over the interconnect 356. The interconnect 356 may include any number of technologies, including industry standard architecture (ISA), extended ISA (EISA), peripheral component interconnect (PCI), peripheral component interconnect extended (PCIx). PCI express (PCIe), or any number of other technologies. The interconnect 356 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 356 may couple the processor 352 to a transceiver 366, for communications with the connected edge devices 362. The transceiver 366 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 362. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 366 (or multiple transceivers) may communicate using multiple standards or radios for communications at a different range. For example, the edge computing node 350 may communicate with close devices, e.g., within about 10 meters, using a local transceiver based on Bluetooth Low Energy (BLE), or another low power radio, to save power. More distant connected edge devices 362, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee@.

A wireless network transceiver 366 (e.g., a radio transceiver) may be included to communicate with devices or services in the edge cloud 395 via local or wide area network protocols. The wireless network transceiver 366 may be a low-power wide-area (LPWA) transceiver that follows the IEEE 802.15.4, or IEEE 802.15.4g standards, among others. The edge computing node 350 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 366, as described herein. For example, the transceiver 366 may include a cellular transceiver that uses spread spectrum (SPA/SAS) communications for implementing high-speed communications. Further, any number of other protocols may be used, such as Wi-Fi® networks for medium speed communications and provision of network communications. The transceiver 366 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 368 may be included to provide a wired communication to nodes of the edge cloud 395 or to other devices, such as the connected edge devices 362 (e.g., operating in a mesh). The wired communication may provide an Ethernet connection or may be based on other types of networks, such as Controller Area Network (CAN), Local Interconnect Network (LIN). DeviceNet. ControlNet, Data Highway+, PROFIBUS, or PROFINET, among many others. An additional NIC 368 may be included to enable connecting to a second network, for example, a first NIC 368 providing communications to the cloud over Ethernet, and a second NIC 368 providing communications to other devices over another type of network.

Given the variety of types of applicable communications from the device to another component or network, applicable communications circuitry used by the device may include or be embodied by any one or more of components 364, 366, 368, or 370. Accordingly, in various examples, applicable means for communicating (e.g., receiving, transmitting, etc.) may be embodied by such communications circuitry.

The edge computing node 350 may include or be coupled to acceleration circuitry 364, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 356 may couple the processor 352 to a sensor hub or external interface 370 that is used to connect additional devices or subsystems. The devices may include sensors 372, such as accelerometers, level sensors, flow sensors, optical light sensors, camera sensors, temperature sensors, global navigation system (e.g., GPS) sensors, pressure sensors, barometric pressure sensors, and the like. The hub or interface 370 further may be used to connect the edge computing node 350 to actuators 374, such as power switches, valve actuators, an audible sound generator, a visual warning device, and the like.

In some optional examples, various input/output (I/O) devices may be present within or connected to, the edge computing node 350. For example, a display or other output device 384 may be included to show information, such as sensor readings or actuator position. An input device 386, such as a touch screen or keypad may be included to accept input. An output device 384 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 350. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 376 may power the edge computing node 350, although, in examples in which the edge computing node 350 is mounted in a fixed location, it may have a power supply coupled to an electrical grid, or the battery may be used as a backup or for temporary capabilities. The battery 376 may be a lithium ion battery, or a metal-air battery, such as a zinc-air battery, an aluminum-air battery, a lithium-air battery, and the like.

A battery monitor/charger 378 may be included in the edge computing node 350 to track the state of charge (SoCh) of the battery 376, if included. The battery monitor/charger 378 may be used to monitor other parameters of the battery 376 to provide failure predictions, such as the state of health (SoH) and the state of function (SoF) of the battery 376. The battery monitor/charger 378 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 378 may communicate the information on the battery 376 to the processor 352 over the interconnect 356. The battery monitor/charger 378 may also include an analog-to-digital (ADC) converter that enables the processor 352 to directly monitor the voltage of the battery 376 or the current flow from the battery 376. The battery parameters may be used to determine actions that the edge computing node 350 may perform, such as transmission frequency, mesh network operation, sensing frequency, and the like.

A power block 380, or other power supply coupled to a grid, may be coupled with the battery monitor/charger 378 to charge the battery 376. In some examples, the power block 380 may be replaced with a wireless power receiver to obtain the power wirelessly, for example, through a loop antenna in the edge computing node 350. A wireless battery charging circuit, such as an LTC4020 chip from Linear Technologies of Milpitas, Calif. among others, may be included in the battery monitor/charger 378. The specific charging circuits may be selected based on the size of the battery 376, and thus, the current required. The charging may be performed using the Airfuel standard promulgated by the Airfuel Alliance, the Qi wireless charging standard promulgated by the Wireless Power Consortium. or the Rezence charging standard, promulgated by the Alliance for Wireless Power, among others.

The storage 358 may include instructions 382 in the form of software, firmware, or hardware commands to implement the techniques described herein. Although such instructions 382 are shown as code blocks included in the memory 354 and the storage 358, it may be understood that any of the code blocks may be replaced with hardwired circuits, for example, built into an application specific integrated circuit (ASIC).

In an example, the instructions 382 provided via the memory 354, the storage 358, or the processor 352 may be embodied as a non-transitory, machine-readable medium 360 including code to direct the processor 352 to perform electronic operations in the edge computing node 350. The processor 352 may access the non-transitory, machine-readable medium 360 over the interconnect 356. For instance, the non-transitory, machine-readable medium 360 may be embodied by devices described for the storage 358 or may include specific storage units such as optical disks, flash drives, or any number of other hardware devices. The non-transitory, machine-readable medium 360 may include instructions to direct the processor 352 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 382 on the processor 352 (separately, or in combination with the instructions 382 of the machine readable medium 360) may configure execution or operation of a trusted execution environment (TEE) 390. In an example, the TEE 390 operates as a protected area accessible to the processor 352 for secure execution of instructions and secure access to data. Various implementations of the TEE 390, and an accompanying secure area in the processor 352 or the memory 354 may be provided, for instance, through use of Intel® Software Guard Extensions (SGX) or ARM® TrustZone® hardware security extensions. Intel® Management Engine (ME), or Intel® Converged Security Manageability Engine (CSME). Other aspects of security hardening, hardware roots-of-trust, and trusted or protected operations may be implemented in the device 350 through the TEE 390 and the processor 352.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

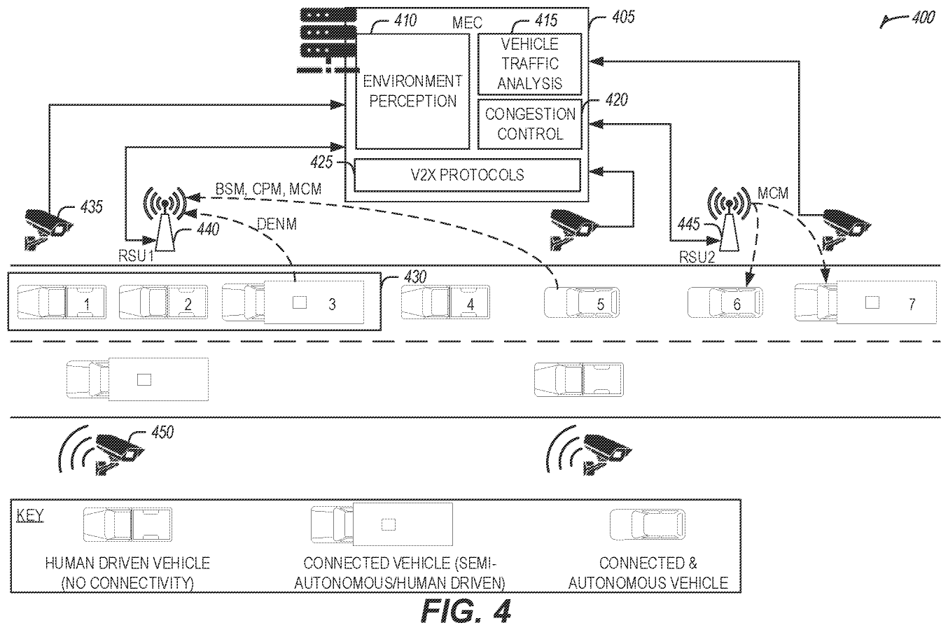

FIG. 4 is a block diagram of an example of an environment 400 and a system 405 for collaborative detection and avoidance of phantom traffic jams, according to an embodiment. The environment 400 includes a highway with mixed traffic of vehicles that include CAVs, connected vehicles, and human driven vehicles. Sensors 435 (e.g., cameras, LIDAR, etc.) are placed for coverage along a stretch of the highway and the sensor data is streamed to the system 405. In an example, the system 405 may be executing on a MEC platform. Road-side units (RSUs), including RSU1 440 and RSU2 445, deployed along the highway provide additional information to the system 405 from BSM, CPM, MCM, and DENM messages broadcasted by CAVs and connected vehicles. Wireless internet protocol (IP) cameras 450 and other external sensors may provide additional CPM data.

The system 405 includes an environmental perception engine 410 that applies perception and fusion algorithms on the input data received from the sensors 435 and the RSUs to generate live kinematic and semantic information of the vehicles on the stretch of the highway. The redundant information from the sensors 435 with overlapping field of views is used to mitigate false-alarms, faulty sensors, etc. This kinematic and semantic information is used by a traffic analysis engine 415 that applies a phantom jam detection algorithm to detect any perturbations, such as perturbation 430 caused by hard braking of a vehicle, that may potentially lead to a phantom jam. To avoid phantom jams, a congestion control engine 420 generates MCMs targeting a group of CAVs and connected vehicles with instructions to avoid the propagation of these perturbations via V2X protocols 425. The MCMs may contain instructions for vehicles, by way of example and not limitation, to decelerate at a particular rate and increase the headway distance/time to specific value, to safely move to a different lane with lower vehicle density to break the propagation of perturbation in current lane, etc. The kinematic and sematic information of the vehicles may be used to estimate vehicle density and provide recommendations on speed limits to all the vehicles via variable speed limit sign boards.

When traffic density is high enough (e.g., based on number of vehicles per minute, following distances, etc.) in the highway, synchronized flow of vehicles takes place. If the perturbations are unchecked, it may propagate into upstream traffic resulting in a phantom traffic jam. To avoid the propagation of perturbations the congestion control engine 420 obtains inputs from the vehicle traffic analysis engine 415 and performs a variety of phantom traffic jam mitigation techniques. The congestion control engine 420 keeps track of vehicle densities and provides periodic driving advisories (DAs) that include recommendations for speed, headway distance/time, deceleration rate, etc. Because different sections and lanes of the highway may have different densities, different DAs may be generated for different sections and lanes. Different DAs may be generated for autonomous vehicles and manually driven vehicles because response times may differ between autonomous vehicles and human driven vehicles.

The DAs may be transmitted in different forms. For example, for CAVs and CVs. MCMs containing the DAs may be broadcasted by the RSUs over V2X communications by the V2X protocols 425. In CAVs and semi-autonomous CVs (e.g., vehicles with features such as adaptive cruise control (ACC), cooperative adaptive cruise control (CACC), etc.), the DAs may be enforced automatically (e.g., subject to driver/manufacturer settings, permissions, etc.). In manually driven CVs, relevant DAs may be provided to drivers via a head-up display (HUD). For conventional vehicles without connectivity, the relevant DAs may be provided via variable message sign (VMS) boards along the roadway.

When the traffic density is high and a perturbation is detected, then the congestion control engine 420 obtains details of the perturbation 430 from the vehicle traffic analysis engine 415 such as the location on highway, lane identity, number of vehicles currently slowed down, etc.

The congestion control engine 420 mitigates propagation of the perturbation. The DA or VMS boards for an affected highway section and the upstream sections may be updated immediately with reduced speed and increased headway distance/time. The RSUs in the affected highway section and upstream sections may broadcast MCMs for the CAVs and CVs in the affected lane(s) to reduce speed, increase headway distance/time, safely move to different lane(s) that have low congestion, etc.

The vehicle traffic analysis engine 415 stores information for the CAVs and CVs currently on the highway based on their periodic broadcast messages. The congestion control engine 420 obtains kinematic information of those vehicles and generates customized MCMs for the vehicles. For example, RSU2 445 may send customized MCMs to vehicle 6 and vehicle 7 to move to the adjacent lane that is less congested.

The system 405 detects perturbations and mitigates phantom traffic jams in mixed traffic typical of a highway composed of different types of vehicles: CAVs. CVs. and human driven vehicles. Through the infrastructure deployed sensors 435 and RSUs, the system 405 estimates the kinematics of vehicles of various types. However, because different vehicles have different capabilities in terms of response times, compliance to DAs, compute resources, communications, sensors, etc., the congestion control engine 420 may generate different levels of DAs and send them via different modes of communication.

Connected and Autonomous Vehicles (CAVs) are a sophisticated vehicle type equipped with advanced sensors and computing resources capable of environmental perception, autonomous driving (AD) stack, and V2X communications. A CAV periodically broadcasts BSM. CAM, CPM. DENM and other messages that contain live information about kinematics as well as environmental perception data from the perspective of the CAV. This information is utilized by the system 405 to improve environmental perception accuracy of the environmental perception engine 410 and overcome adverse effects such as occlusions at infrastructure sensors 435. A CAV may broadcast a DENM message when it experiences a perturbation, for example, unexpected abrupt braking. This information helps the system 405 improve detection accuracy of perturbations and may allow the congestion control engine 420 to take early action to suppress propagation of the perturbance 430. Because a CAV is equipped with perception capabilities, the vehicular traffic analysis engine 415 may be implemented in the CAV to detect perturbations at other vehicles within its sensing range. Thus the vehicle traffic analysis engine 415 may be distributed among the MEC and the CAVs. The CAV may broadcast a DENM message when it detects a perturbation, for example, in an adjacent lane.

The MCMs with DAs broadcasted/groupcasted/unicasted by the RSUs may be received and enforced by the CAV to avoid phantom jams. In a safety driving model (SDM) enabled CAV, the received DAs from the RSU may be enforced in the CAV by reconfiguring its RSS parameters. For example, the minimum braking deceleration parameter a_(min,brake) in the RSS model may be reconfigured based on the DA from the RSU. The RSS model automatically calculates and sets the safe longitudinal distance (e.g., headway distance/time) such that it does not have to apply abrupt braking.

Connected Vehicles (CVs) may support V2X communications but may lack advanced sensing and environmental perception capabilities. The CVs may be manually driven or may be semi-autonomous with capabilities like adaptive cruise control (ACC) and cooperative adaptive cruise control (CACC). A CV may broadcast a DENM message when it experiences the perturbation 430, for example, unexpected abrupt braking. This information may help the system 405 improve detection accuracy of the perturbation 430 and may allow the congestion control engine 420 to take early action to suppress propagation of the perturbation 430. Detection of perturbations may be implemented in CVs using IMU sensors and involves low complexity computations. The MCMs with DAs broadcasted/groupcasted/unicasted by the RSU may be received and enforced by the CV to avoid phantom traffic jams. Unlike CAVs that may execute advanced maneuvers automatically, the CVs may execute basic DAs. The CVs equipped with ACC or CACC may perform automatic adjustments of speed, headway distance/time, and deceleration rate. The manually driven CVs may implement mechanisms to display the basic DAs on a HUD including recommended speed, lane change advice, etc.

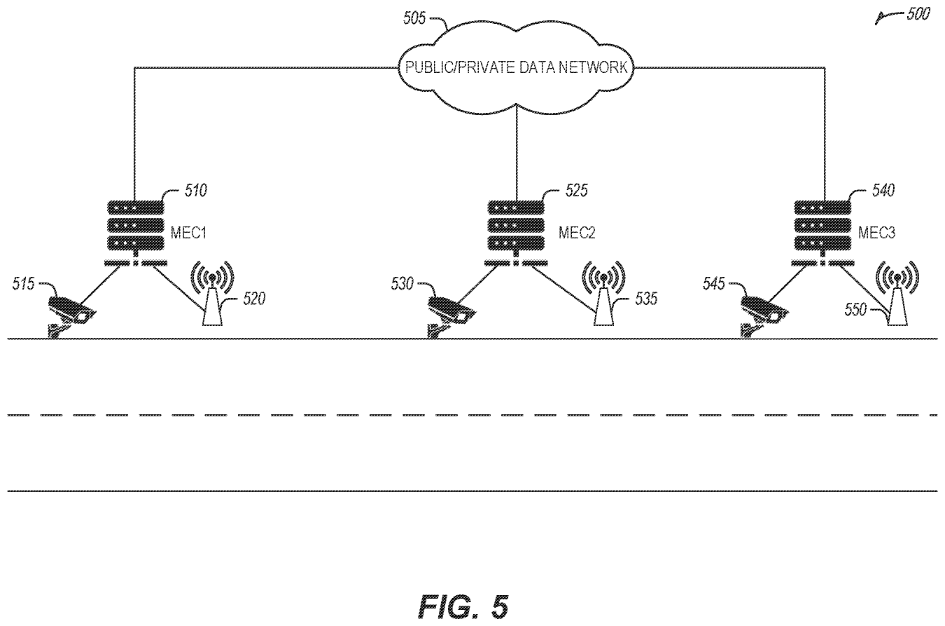

FIG. 5 illustrates an example of a distributed multi-access edge computing architecture 500 with a backhaul data network for collaborative detection and avoidance of phantom traffic jams, according to an embodiment. Multiple MEC platforms may be used to process data from a large number of sensors in real time and to extend coverage length of the highway. As shown in FIG. 5, multiple MEC platforms such as MEC1 510. MEC2 525, and MEC3 540 are distributed along different sections of a highway and are connected to respective sensors 515, 530, and 545 and respective roadside communication devices 520, 535, and 550. In this distributed architecture, the MECs are interconnected through a private or public backhaul data network 505. The MECs share perturbation detection information (e.g., provided by the system 405 as described in FIG. 4, etc.) with each other and take coordinated actions. For example, when MEC1 510 detects a perturbation in a high traffic scenario, MEC1 510 shares the information with MEC2 525 and MEC3 540. MEC2 525 and MEC3 540 generate and send MCMs to vehicles in their respective coverage areas.

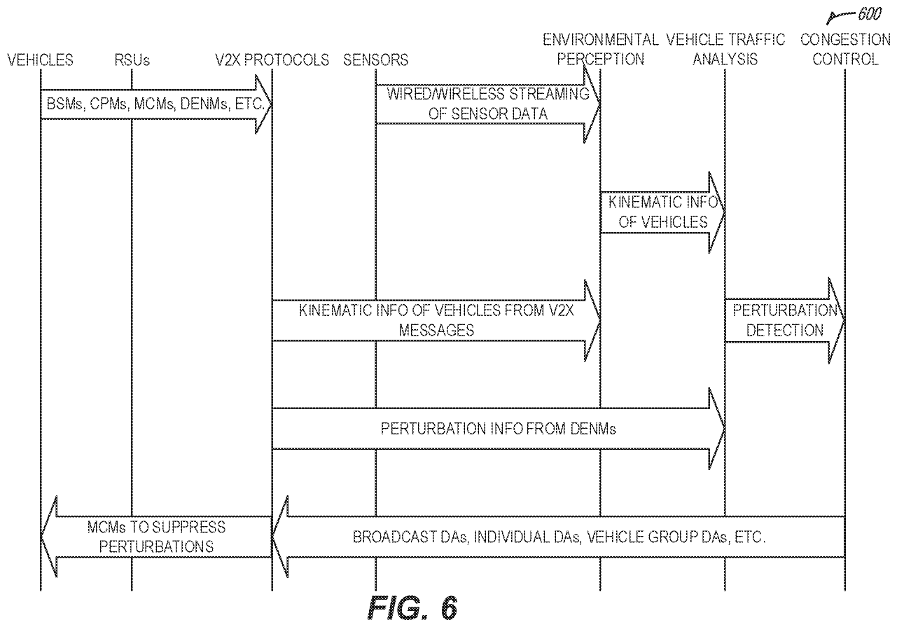

FIG. 6 is a data flow diagram of an example perturbation detection and mitigation process 600 for collaborative detection and avoidance of phantom traffic jams, according to an embodiment. As illustrated in FIG. 4, a perturbation 430 occurs due to hard braking of a vehicle. This perturbation 430 is detected in by the system 405 as described in FIG. 4 using the sensor information and V2X messages (BSM, CPM, etc.) from vehicles. The system 405 generates MCMs targeted to a group of vehicles in right side of figure, with instructions to avoid the potential phantom jam.

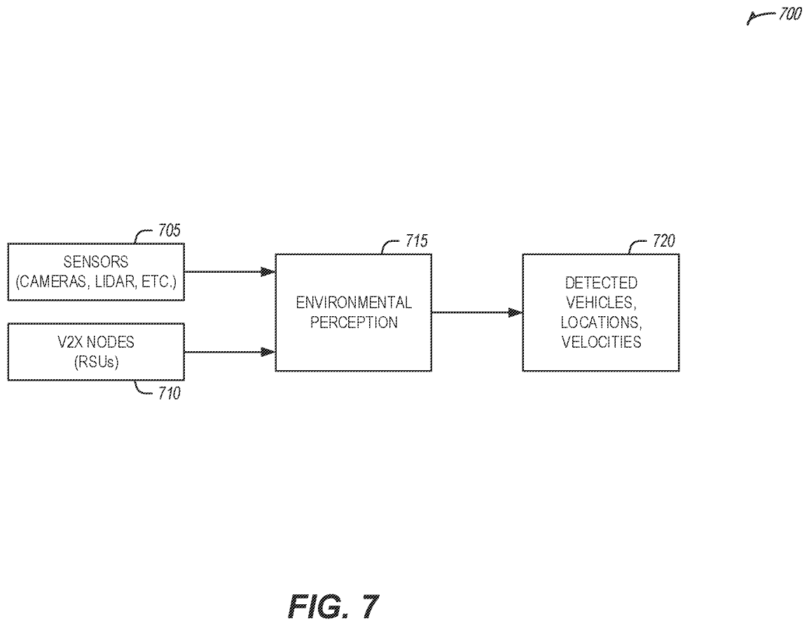

FIG. 7 is a block diagram of an example of an environment perception architecture 700 in a multi-access edge computing network for collaborative detection and avoidance of phantom traffic jams, according to an embodiment.

The environment perception infrastructure 700 is formed by sensors 705, V2X nodes 710, and a MEC platform that includes an environmental perception engine 715. The sensors 705 may include cameras. LIDARs, depth cameras, etc. and are deployed along the highway with appropriate coverage to capture sufficient information of vehicles in the highway. The sensors 705 may be connected to the MEC via wired or wireless connectivity.

The V2X communication nodes 710, like RSUs, provide additional information broadcasted by connected vehicles in the highway. The connected vehicles periodically transmit messages such as, by way of example and not limitation, BSMs or cooperative awareness messages (CAMs) that contain vehicle mobility information such as location, velocity, and the like. The CAVs may broadcast more advanced messages like CPMs that contain information perceived by a CAV using its onboard sensors.

The environmental perception engine 715 consists of software running on the MEC platform that collects and processes the data from sensors 705 and V2X nodes 710 collaboratively (e.g., via fusion techniques, etc.) to develop a contextual understanding of the environment. The environmental perception engine 715 may provide real-time environmental perception capabilities with accurate semantic and kinematic details. A variety of information 720 may be provided by the environmental perception engine 715 including, but not limited, to detection of vehicles on the highway segment, locations (e.g., coordinates, associated lanes, etc.) of the vehicles, and velocities of the vehicles.

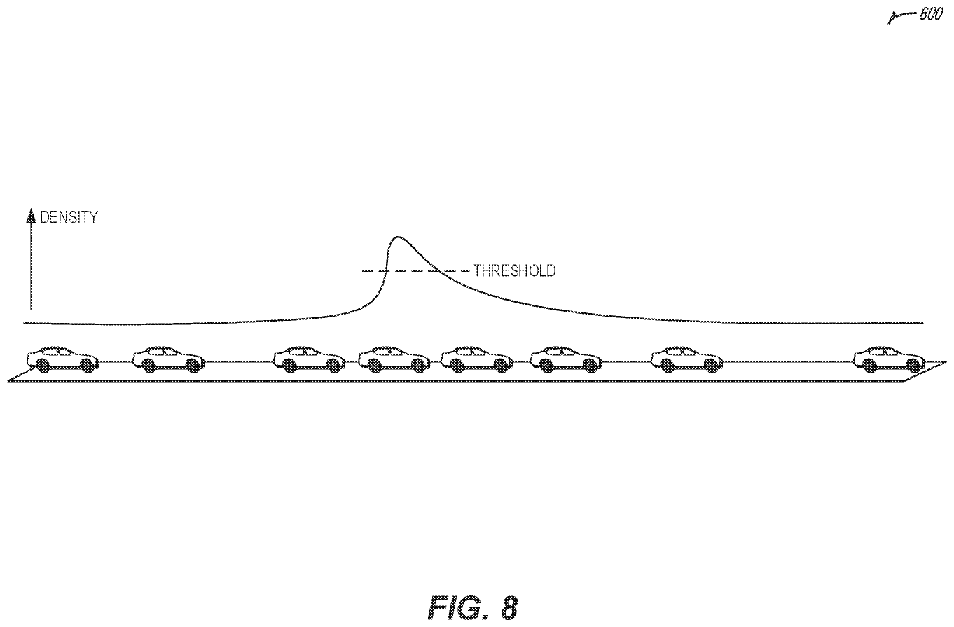

FIG. 8 illustrates an example of a of spike in vehicle density 800 resulting from a perturbation. The vehicle traffic analysis service (e.g., the traffic analysis engine 415 as described in FIG. 4, etc.) running on the MEC platform implements phantom jam detection/prediction algorithms that use vehicles' kinematics input from the environment perception engine (e.g., environment engine 715 as described in FIG. 7, etc.). Traffic analysis may involve computation of algorithms to analyze the dynamics of the traffic and detect potential congestion points. The state-of-the-art literature provides different methods for detection of phantom traffic jams, but mainly on detection at vehicle side using V2V communications. Below are some example methods that can be used to detect phantom traffic jams at the infrastructure:

The coordinates of vehicles can be used to calculate vehicle density along the stretch of highway. The highway length can be divided into small segments or a moving window may be used to calculate local density as a function of highway location. The density may be computed separately for different lanes to implement lane-level phantom jam detection and mitigation. The density function along the highway length is used to detect perturbations that may lead to phantom jams. For example, when a vehicle brakes abruptly, the vehicles following behind come close to each other (e.g., due to reaction time of driver or autonomous driving agent) causing a spike (e.g., a wave in traffic known as a jamiton, etc.) in the density function as illustrated in FIG. 8. The perturbations may be detected using a threshold on the density or normalized density.

In another example, perturbations may be detected using the velocities of vehicles. When a group of consecutive vehicles have lower velocities compared to the average velocity of overall highway, that indicates a local perturbation. The inter-vehicle distances can also be used in conjunction with velocities because the perturbations typically cause reduction in inter-vehicle distances along with reduced velocities.

In yet another example, a connected vehicle (or a CAV) on the highway may also proactively assist the infrastructure by broadcasting notification messages like DENM to inform about perturbations experienced by the vehicle. For example, in FIG. 4, when vehicle 1 applies brakes abruptly it causes a chain reaction which eventually causes vehicle 4 (a CV) to apply brakes. Then, vehicle 4 broadcasts a DENM message to notify the MEC or other connected vehicles about the perturbation along with other relevant information like the location, velocity, deceleration rate, detection confidence level, etc. The DENM message format contains necessary fields to accurately describe the perturbation.

In low traffic scenarios, the perturbations in traffic flow are unlikely to cause phantom jams. Hence, the traffic analysis engine may calculate the overall vehicle density in the highway or large sections of highway. If the density in the highway, a section of highway, or a lane increases beyond certain level, further computations for detecting the perturbations are activated. This way, the MEC saves on computational power consumption during times when traffic density is low.

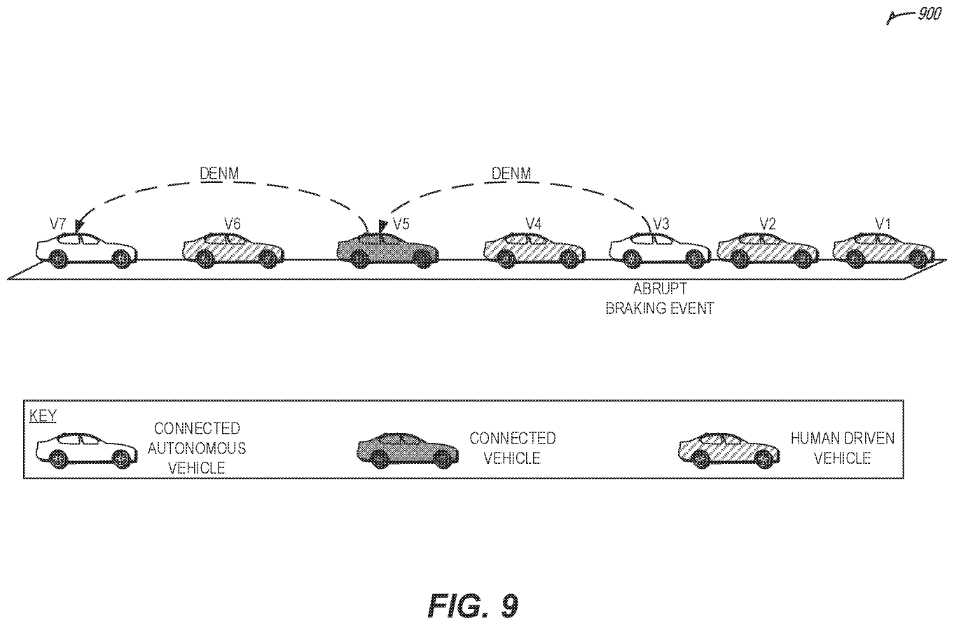

FIG. 9 illustrates an example of multi-hop vehicle-to-vehicle communications-based phantom jam mitigation 900 for collaborative detection and avoidance of phantom traffic jams, according to an embodiment. When there is no infrastructure support on the highway to mitigate phantom jams, the CAVs and CVs may implement mechanisms to detect and suppress the propagation of perturbations using V2V communications. Effectiveness of these mechanisms depends on penetration rate of CAVs and CVs in the traffic flow. Effectiveness increases as CAV and CV penetration rates increase.

As shown in FIG. 9, vehicle 3 may experience a perturbation as a result of an abrupt braking event. Vehicle 3 may broadcast a DENM message to vehicle 5. Vehicle 5 may include a vehicle analysis engine (e.g., the vehicle analysis engine 415 as described in FIG. 4, etc.) and may use the DENM message to generate a DA to inform the driver of a suggested change to operation of the vehicle or to automatically adjust an operating parameter of the vehicle to mitigate propagation of the perturbation. Vehicle 5 may transmit a DENM (e.g., the same DENM, an adjusted DENM, etc.) to vehicle 7 which may likewise generate a DA to mitigate the perturbation. DENMs may be provided upstream until the perturbation is no longer detected in the traffic stream.

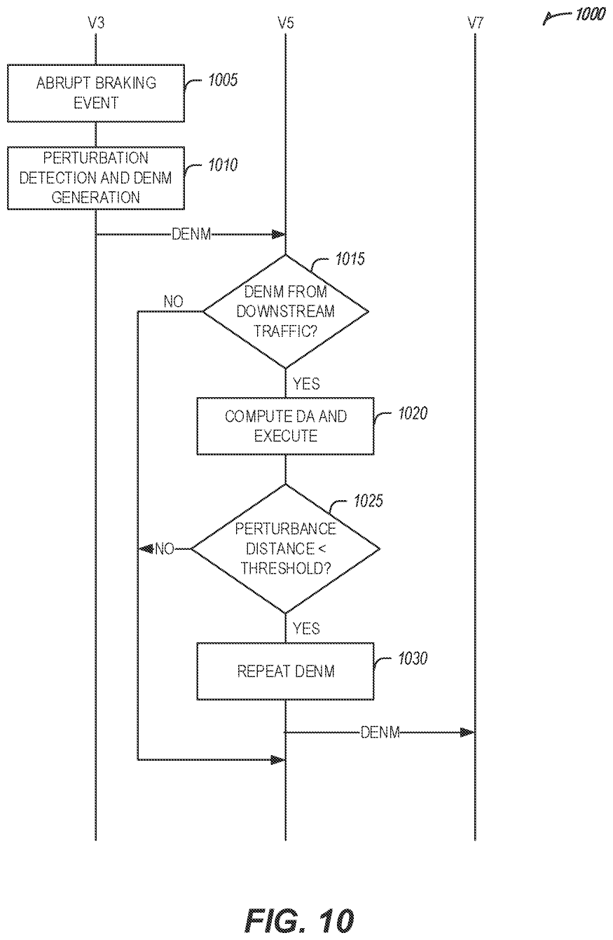

FIG. 10 is a flow diagram of an example of a process 1000 for vehicle-to-vehicle communications-based phantom jam mitigation mechanism for collaborative detection and avoidance of phantom traffic jams, according to an embodiment.

At operation 1005, a CAV V3 experiences a perturbation. At operation 1010, the CAV V3 detects the perturbation and generates a DENM. The DENM is broadcast to a vehicle V5 to report the details of perturbation.

At decision 1015, the vehicle V5 receives the DENM and determines if the DENM was sent from downstream traffic. If not, vehicle V5 does not act on the DENM. If the DENM was sent from downstream traffic, at operation 1020, the vehicle V5 computes a DA that includes suitable speed, headway distance/time, maximum deceleration, etc. and executes the computed DA. The computation of DA may be based on the information available from V2X messages from other vehicles.

At decision 1025, the vehicle V5 decides whether to re-broadcast the DENM based on a criteria. For example, if the original perturbation location is nearby (e.g., based on a threshold, etc.). If the criteria is not met, the process 1000 ends. If the criteria is met, at operation 1030, the vehicle V5 re-broadcasts the DENM. Other criteria, like number of hops, validity duration (keep-alive-forwarding), etc., may also be used. The vehicle V7 receives the DENM and repeats decision 1015, operation 1020, decision 1025, and operation 1025 similar to vehicle V5.

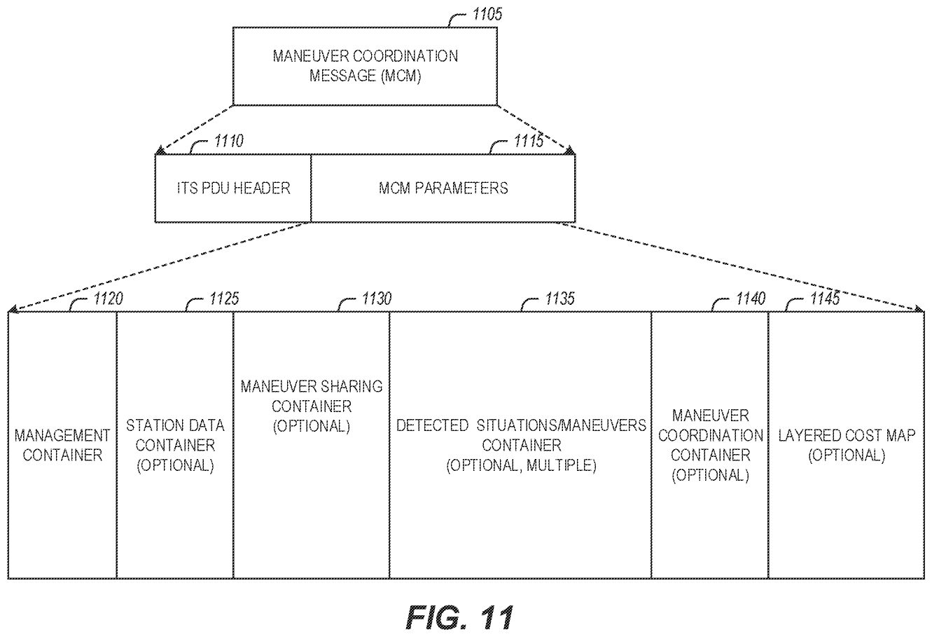

FIG. 11 is a block diagram of an example of a maneuver coordination message (MCM) format and structure for collaborative detection and avoidance of phantom traffic jams, according to an embodiment. The maneuver coordination message 1105 may provide features as described in FIGS. 4-10.

The RSUs provide instructions to the CAVs and CVs using MCMs. In an example, the MCM 1105 may be formatted according to a standard of The European Telecommunications Standards Institute (ETSI). In the MCM message format, an intelligent transport systems (ITS) protocol data unit (PDU) header 1110 is a mandatory field that defines message type and station/node identifier (ID). The MCM Parameters 1115 consist of several sub-containers. A management container 1120 provides basic information about the message such as station type generating message, a message ID, message type (either MCM/CPM), periodic full size MCM, periodic incremental MCM or event-triggered MCM, segmentation information, etc. There are several other optional containers in the MCM Parameters 1115 such as a station data container 1125, a maneuver sharing container 1130, a detected situations/maneuvers container(s) 1135, a maneuver coordination container (MCC) 1140, and a layered cost map 1145.

The MCC 1140 may be used to send maneuver coordination requests and responses between the ITS stations. The MCC 1140 is reused for RSU instructions to the CAVs and CVs for mitigating phantom jams. Additional fields and definitions are added to the MCC 1140. The RSU may send MCMs in unicast, groupcast, or broadcast modes depending on requirements. The level of DA information is different for the unicast, the groupcast, and the broadcast modes.

In broadcast mode, the RSU may send MCMs that contain general DA information including, but not limited to intended vehicle type (CAV, CV with ACC, CV with CACC, human driven CV, etc.), recommended speed, recommended headway distance/time, recommended maximum deceleration (e.g., to avoid perturbations), recommended lane/s to avoid (e.g., move to other lanes to avoid congestion),

In groupcast mode, the RSU may address the MCMs to a specific group of vehicles may include but is not limited to group ID; IDs of member vehicles; and a list of maneuver coordination tasks that include target vehicle IDs, speed, headway distance/time, maximum deceleration, change to target lane (optional), advice trajectory (optional), etc.

In unicast mode, the RSU may address the MCM to a specific vehicle that may contain target vehicle ID, recommended speed, headway distance/time, maximum deceleration, change to target lane (optional), advice trajectory (optional), etc.

A vehicle may send an acknowledgement in response to the unicast and groupcast MCMs that may contain a vehicle ID and group ID (for groupcast response), planned speed, headway distance/time, maximum deceleration, planned lane change, planned trajectory, etc.

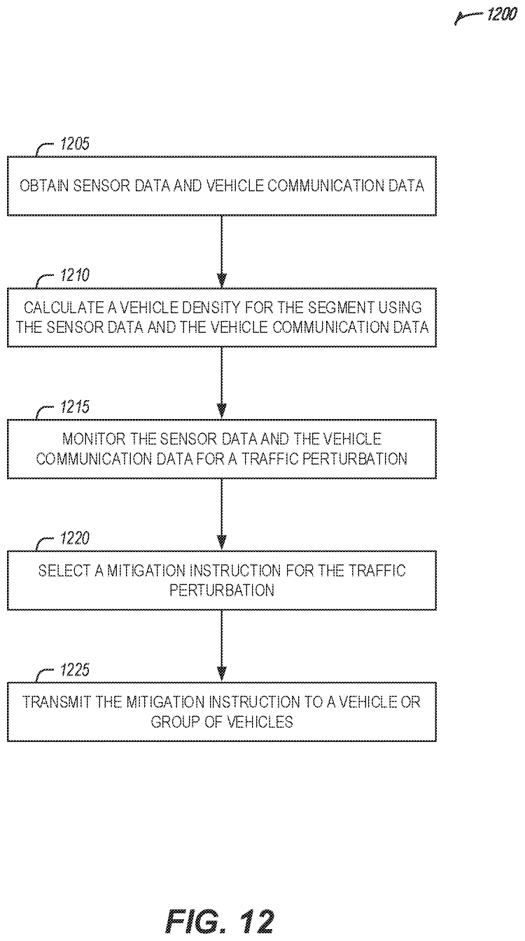

FIG. 12 illustrates an example of a method 1200 for collaborative detection and avoidance of phantom traffic jams, according to an embodiment. The method 1200 may provide features as described in FIGS. 4-11.

At operation 1205, sensor data for a segment of a roadway and vehicle communication data for vehicles travelling on the segment is obtained (e.g., by the environment perception engine 410 as described in FIG. 4, etc.). In an example, the sensor data may be obtained from an optical sensor included in a camera, a depth camera, or a light detection and ranging sensor that observes the segment of the roadway. In an example, the vehicle communication data may be obtained from a roadside communication device in proximity of the segment of the roadway.

At operation 1210, a vehicle density may be calculated (e.g., by the vehicle traffic analysis engine 415 as described in FIG. 4, etc.) for the segment using the sensor data and the vehicle communication data. At operation 1215, the sensor data and the vehicle communication data may be monitored for a traffic perturbation based on the calculated vehicle density.

At operation 1220, a mitigation instruction may be selected (e.g., by the congestion control engine 420 as described in FIG. 4, etc.) for the traffic perturbation upon detection of the traffic perturbation. In an example, vehicle density values may be obtained for a spatial window calculated from the sensor data and a spike in the vehicle density above a threshold may be identified as the traffic perturbation. In another example, decentralized environmental notification messages may be obtained from vehicles traveling along the segment of the roadway. Characteristics of the perturbation may be determined based on an evaluation of a location, a velocity, a deceleration rate, and a detection confidence level included in the decentralized environmental notification messages and selection of the mitigation may be based on the characteristics of the perturbation

At operation 1225, the mitigation instruction may be transmitted (e.g., by the congestion control engine 420 as described in FIG. 4, etc.) to a vehicle or group of vehicles traveling on the roadway (e.g., using the V2X protocols 425 as described in FIG. 4, etc.). In an example, a mitigation plan may be determined for avoiding a phantom traffic jam based on the perturbation by evaluating detection information associated with the perturbation. A driving advisory may be generated based on the mitigation plan and the driving advisory may be transmitted as the mitigation instruction. In an example, a type may be determined for the vehicle or the group of vehicles and the driving advisory may be generated in part based on the determined type. In another example, an operating lane may be determined for the vehicle or the group of vehicles and the driving advisory may be generated in part based on the determined operating lane. In yet another example, a roadway segment may be determined for the vehicle or the group of vehicles and the driving advisory may be generated in part based on the determined roadway segment.

In an example, a maneuver coordination message may be generated using the driving advisory and the maneuver coordination message may be transmitted to a vehicle or a group of vehicles operating on the segment of the roadway. In an example, the maneuver coordination message may include a management container that includes a station type generating message, a message ID, a message type, and segmentation information. In an example, the maneuver coordination message may include a maneuver coordination container and information may be transmitted between a first roadside communication device and a second roadside communication device via the maneuver coordination container. In an example, the maneuver coordination message may be transmitted in broadcast, groupcast, or unicast mode. In an example, the maneuver coordination message is forwarded to a multi-access edge computing node on a second segment of the roadway for delivery to a vehicle operating on the second segment of the roadway via a roadside communication device in proximity of the second segment of the roadway.

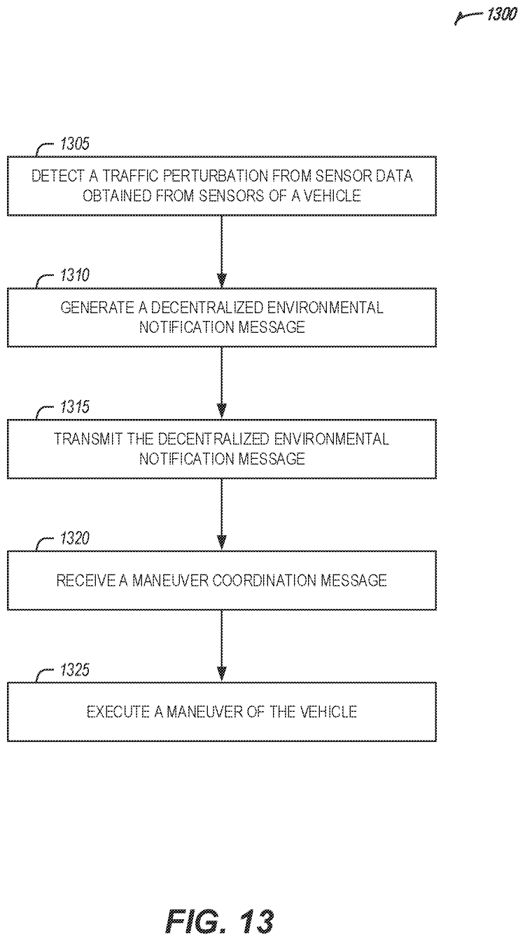

FIG. 13 illustrates an example of a method 1300 for collaborative detection and avoidance of phantom traffic jams, according to an embodiment. The method 1300 may provide features as described in FIGS. 4-11.

At operation 1305, a traffic perturbation is detected based on an evaluation of sensor data obtained from sensors of a vehicle. At operation 1310, a decentralized environmental notification message is generated (e.g., by the environment perception engine 410 as described in FIG. 4, etc.) based on the detected traffic perturbation. At operation 1315, the decentralized environmental notification message is transmitted (e.g., via the V2X protocols 425 as described in FIG. 4, etc.) to a roadside communication device.

At operation 1320, a maneuver coordination message is received from the roadside communication device. At operation 1325, a maneuver of the vehicle is executed based on the maneuver coordination message. For example, an onboard maneuver coordination module included with a CAV or a CV may receive the maneuver coordination message and may execute the maneuver. In an example, it may be determined that the roadside communication device is not available and the decentralized environmental notification message may be transmitted to a second vehicle.

In an example, a decentralized environmental notification message may be received from a second vehicle. A mitigation instruction may be generated based on the decentralized environmental notification message from the second vehicle and the maneuver of the vehicle may be executed based on the mitigation instruction. In another example, safety driving model parameters of the vehicle may be reconfigured based on the mitigation instruction.

In an example, subsequent decentralized environmental notification messages may be generated at periodic intervals until expiration of a time window associated with the traffic perturbation and the subsequent decentralized environmental notification messages may be transmitted to the roadside communication device. In an example, the periodic intervals may be determined based on the traffic perturbation. In an example, safety driving model parameters of the vehicle may be reconfigured based on the maneuver coordination message.

In another example, a distance of the vehicle may be determined from a location of the traffic perturbation. Subsequent decentralized environmental notification messages may be generated at periodic intervals until the distance exceeds a threshold distance from the traffic perturbation, and the subsequent decentralized environmental notification messages may be transmitted to the roadside communication device.

### ADDITIONAL NOTES & EXAMPLES

Example 1 is a system for traffic perturbation detection comprising: at least one processor; and memory including instructions that, when executed by the at least one processor, cause the at least one processor to perform operations to: obtain sensor data for a segment of a roadway and vehicle communication data for vehicles travelling on the segment; calculate a vehicle density for the segment using the sensor data and the vehicle communication data; based on the calculated vehicle density, monitor the sensor data and the vehicle communication data for a traffic perturbation; upon detection of the traffic perturbation, select a mitigation instruction for the traffic perturbation; and transmit the mitigation instruction to a vehicle or group of vehicles traveling on the roadway.

In Example 2, the subject matter of Example 1 wherein the sensor data is obtained from an optical sensor included in a camera, a depth camera, or a light detection and ranging sensor that observes the segment of the roadway.

In Example 3, the subject matter of Examples 1-2 wherein the vehicle communication data is obtained from a roadside communication device in proximity of the segment of the roadway.

In Example 4, the subject matter of Examples 1-3 includes, the instructions to detect the traffic perturbation further comprising instructions that, when executed by the at least one processor, cause the at least one processor to perform operations to: obtain vehicle density values for a spatial window calculated from the sensor data; and identify a spike in the vehicle density above a threshold as the traffic perturbation.

In Example 5, the subject matter of Examples 1-4 includes, the instructions to detect the traffic perturbation further comprising instructions that, when executed by the at least one processor, cause the at least one processor to perform operations to: obtain decentralized environmental notification messages from vehicles traveling along the segment of the roadway; and determine characteristics of the perturbation based on an evaluation of a location, a velocity, a deceleration rate, and a detection confidence level included in the decentralized environmental notification messages, wherein selection of the mitigation is based on the characteristics of the perturbation.

In Example 6, the subject matter of Examples 1-5 includes, the memory further comprising instructions that, when executed by the at least one processor, cause the at least one processor to perform operations to: determine a mitigation plan for avoiding a phantom traffic jam based on the perturbation by evaluating detection information associated with the perturbation; and generate a driving advisory based on the mitigation plan, wherein the driving advisory is transmitted as the mitigation instruction.

In Example 7, the subject matter of Example 6 includes, the memory further comprising instructions that, when executed by the at least one processor, cause the at least one processor to perform operations to determine a type for the vehicle or the group of vehicles, wherein the driving advisory is generated in part based on the determined type.

In Example 8, the subject matter of Examples 6-7 includes, the memory further comprising instructions that, when executed by the at least one processor, cause the at least one processor to perform operations to determine an operating lane for the vehicle or the group of vehicles, wherein the driving advisory is generated in part based on the determined operating lane.

In Example 9, the subject matter of Examples 6-8 includes, the memory further comprising instructions that, when executed by the at least one processor, cause the at least one processor to perform operations to determine a roadway segment for the vehicle or the group of vehicles, wherein the driving advisory is generated in part based on the determined roadway segment.

In Example 10, the subject matter of Examples 6-9 includes, the memory further comprising instructions that, when executed by the at least one processor, cause the at least one processor to perform operations to: generate a maneuver coordination message using the driving advisory; and transmit the maneuver coordination message to a vehicle or a group of vehicles operating on the segment of the roadway.

In Example 11, the subject matter of Example 10 wherein the maneuver coordination message includes a management container that includes a station type generating message, a message ID, a message type, and segmentation information.

In Example 12, the subject matter of Examples 10-11 wherein the maneuver coordination message includes a maneuver coordination container and the memory further comprising instructions that, when executed by the at least one processor, cause the at least one processor to perform operations to: transmit information between a first roadside communication device and a second roadside communication device using the maneuver coordination container.

In Example 13, the subject matter of Examples 10-12 wherein the maneuver coordination message is transmitted in broadcast, groupcast, or unicast mode.

In Example 14, the subject matter of Examples 10-13 includes, the memory further comprising instructions that, when executed by the at least one processor, cause the at least one processor to perform operations to forward the maneuver coordination message to a multi-access edge computing node on a second segment of the roadway for delivery to a vehicle operating on the second segment of the roadway via a roadside communication device in proximity of the second segment of the roadway.

Example 15 is at least one non-transitory machine-readable medium including instructions for traffic perturbation detection that, when executed by at least one processor, cause the at least one processor to perform operations to: obtain sensor data for a segment of a roadway and vehicle communication data for vehicles travelling on the segment; calculate a vehicle density for the segment using the sensor data and the vehicle communication data; based on the calculated vehicle density, monitor the sensor data and the vehicle communication data for a traffic perturbation; upon detection of the traffic perturbation, select a mitigation instruction for the traffic perturbation; and transmit the mitigation instruction to a vehicle or group of vehicles traveling on the roadway.

In Example 16, the subject matter of Example 15 wherein the sensor data is obtained from an optical sensor included in a camera, a depth camera, or a light detection and ranging sensor that observes the segment of the roadway.

In Example 17, the subject matter of Examples 15-16 wherein the vehicle communication data is obtained from a roadside communication device in proximity of the segment of the roadway.

In Example 18, the subject matter of Examples 15-17 includes, the instructions to detect the traffic perturbation further comprising instructions that, when executed by the at least one processor, cause the at least one processor to perform operations to: obtain vehicle density values for a spatial window calculated from the sensor data; and identify a spike in the vehicle density above a threshold as the traffic perturbation.

In Example 19, the subject matter of Examples 15-18 includes, the instructions to detect the traffic perturbation further comprising instructions that, when executed by the at least one processor, cause the at least one processor to perform operations to: obtain decentralized environmental notification messages from vehicles traveling along the segment of the roadway; and determine characteristics of the perturbation based on an evaluation of a location, a velocity, a deceleration rate, and a detection confidence level included in the decentralized environmental notification messages, wherein selection of the mitigation is based on the characteristics of the perturbation.

In Example 20, the subject matter of Examples 15-19 includes, instructions that, when executed by the at least one processor, cause the at least one processor to perform operations to: determine a mitigation plan for avoiding a phantom traffic jam based on the perturbation by evaluating detection information associated with the perturbation; and generate a driving advisory based on the mitigation plan, wherein the driving advisory is transmitted as the mitigation instruction.

In Example 21, the subject matter of Example 20 includes, instructions that, when executed by the at least one processor, cause the at least one processor to perform operations to determine a type for the vehicle or the group of vehicles, wherein the driving advisory is generated in part based on the determined type.

In Example 22, the subject matter of Examples 20-21 includes, instructions that, when executed by the at least one processor, cause the at least one processor to perform operations to determine an operating lane for the vehicle or the group of vehicles, wherein the driving advisory is generated in part based on the determined operating lane.

In Example 23, the subject matter of Examples 20-22 includes, instructions that, when executed by the at least one processor, cause the at least one processor to perform operations to determine a roadway segment for the vehicle or the group of vehicles, wherein the driving advisory is generated in part based on the determined roadway segment.

In Example 24, the subject matter of Examples 20-23 includes, instructions that, when executed by the at least one processor, cause the at least one processor to perform operations to: generate a maneuver coordination message using the driving advisory; and transmit the maneuver coordination message to a vehicle or a group of vehicles operating on the segment of the roadway.

In Example 25, the subject matter of Example 24 wherein the maneuver coordination message includes a management container that includes a station type generating message, a message ID, a message type, and segmentation information.

In Example 26, the subject matter of Examples 24-25 wherein the maneuver coordination message includes a maneuver coordination container and further comprising instructions that, when executed by the at least one processor, cause the at least one processor to perform operations to: transmit information between a first roadside communication device and a second roadside communication device using the maneuver coordination container.

In Example 27, the subject matter of Examples 24-26 wherein the maneuver coordination message is transmitted in broadcast, groupcast, or unicast mode.

In Example 28, the subject matter of Examples 24-27 includes, instructions that, when executed by the at least one processor, cause the at least one processor to perform operations to forward the maneuver coordination message to a multi-access edge computing node on a second segment of the roadway for delivery to a vehicle operating on the second segment of the roadway via a roadside communication device in proximity of the second segment of the roadway.

Example 29 is a method for traffic perturbation detection comprising: obtaining sensor data for a segment of a roadway and vehicle communication data for vehicles travelling on the segment; calculating a vehicle density for the segment using the sensor data and the vehicle communication data; based on the calculated vehicle density, monitoring the sensor data and the vehicle communication data for a traffic perturbation; upon detection of the traffic perturbation, selecting a mitigation instruction for the traffic perturbation; and transmitting the mitigation instruction to a vehicle or group of vehicles traveling on the roadway.

In Example 30, the subject matter of Example 29 wherein the sensor data is obtained from an optical sensor included in a camera, a depth camera, or a light detection and ranging sensor that observes the segment of the roadway.

In Example 31, the subject matter of Examples 29-30 wherein the vehicle communication data is obtained from a roadside communication device in proximity of the segment of the roadway.

In Example 32, the subject matter of Examples 29-31 wherein detection of the traffic perturbation further comprises: obtaining vehicle density values for a spatial window calculated from the sensor data; and identifying a spike in the vehicle density above a threshold as the traffic perturbation.

In Example 33, the subject matter of Examples 29-32 wherein detection of the traffic perturbation further comprises: obtaining decentralized environmental notification messages from vehicles traveling along the segment of the roadway; and determining characteristics of the perturbation based on an evaluation of a location, a velocity, a deceleration rate, and a detection confidence level included in the decentralized environmental notification messages, wherein selection of the mitigation is based on the characteristics of the perturbation.

In Example 34, the subject matter of Examples 29-33 includes, determining a mitigation plan for avoiding a phantom traffic jam based on the perturbation by evaluating detection information associated with the perturbation; and generating a driving advisory based on the mitigation plan, wherein the driving advisory is transmitted as the mitigation instruction.

In Example 35, the subject matter of Example 34 includes, determining a type for the vehicle or the group of vehicles, wherein the driving advisory is generated in part based on the determined type.

In Example 36, the subject matter of Examples 34-35 includes, determining an operating lane for the vehicle or the group of vehicles, wherein the driving advisory is generated in part based on the determined operating lane.

In Example 37, the subject matter of Examples 34-36 includes, determining a roadway segment for the vehicle or the group of vehicles, wherein the driving advisory is generated in part based on the determined roadway segment.

In Example 38, the subject matter of Examples 34-37 includes, generating a maneuver coordination message using the driving advisory; and transmitting the maneuver coordination message to a vehicle or a group of vehicles operating on the segment of the roadway.

In Example 39, the subject matter of Example 38 wherein the maneuver coordination message includes a management container that includes a station type generating message, a message ID, a message type, and segmentation information.

In Example 40, the subject matter of Examples 38-39 wherein the maneuver coordination message includes a maneuver coordination container and further comprising: transmitting information between a first roadside communication device and a second roadside communication device using the maneuver coordination container.

In Example 41, the subject matter of Examples 38-40 wherein the maneuver coordination message is transmitted in broadcast, groupcast, or unicast mode.

In Example 42, the subject matter of Examples 38-41 includes, forwarding the maneuver coordination message to a multi-access edge computing node on a second segment of the roadway for delivery to a vehicle operating on the second segment of the roadway via a roadside communication device in proximity of the second segment of the roadway.

Example 43 is at least one machine-readable medium including instructions that, when executed by a machine, cause the machine to perform any method of Examples 29-42.

Example 44 is a system comprising means to perform any method of Examples 29-42.

Example 45 is a system for traffic perturbation mitigation comprising: at least one processor; and memory including instructions that, when executed by the at least one processor, cause the at least one processor to perform operations to: detect a traffic perturbation based on an evaluation of sensor data obtained from sensors of a vehicle; generate a decentralized environmental notification message based on the detected traffic perturbation; transmit the decentralized environmental notification message to a roadside communication device; receive a maneuver coordination message from the roadside communication device; and execute a maneuver of the vehicle based on the maneuver coordination message.

In Example 46, the subject matter of Example 45 includes, the memory further comprising instructions that, when executed by the at least one processor, cause the at least one processor to perform operations to: determine that the roadside communication device is not available; and transmit the decentralized environmental notification message to a second vehicle.

In Example 47, the subject matter of Examples 45-46 includes, the memory further comprising instructions that, when executed by the at least one processor, cause the at least one processor to perform operations to: receive a decentralized environmental notification message from a second vehicle; generate a mitigation instruction based on the decentralized environmental notification message from the second vehicle; and execute the maneuver of the vehicle based on the mitigation instruction.

In Example 48, the subject matter of Example 47 includes, the memory further comprising instructions that, when executed by the at least one processor, cause the at least one processor to perform operations to: reconfigure safety driving model parameters of the vehicle based on the mitigation instruction.

In Example 49, the subject matter of Examples 45-48 includes, the memory further comprising instructions that, when executed by the at least one processor, cause the at least one processor to perform operations to: generate subsequent decentralized environmental notification messages at periodic intervals until expiration of a time window associated with the traffic perturbation; and transmit the subsequent decentralized environmental notification messages to the roadside communication device.

In Example 50, the subject matter of Example 49 wherein the periodic intervals are determined based on the traffic perturbation.

In Example 51, the subject matter of Examples 45-50 includes, the memory further comprising instructions that, when executed by the at least one processor, cause the at least one processor to perform operations to: reconfigure safety driving model parameters of the vehicle based on the maneuver coordination message.

In Example 52, the subject matter of Examples 45-51 includes, the memory further comprising instructions that, when executed by the at least one processor, cause the at least one processor to perform operations to: determine a distance of the vehicle from a location of the traffic perturbation; generate subsequent decentralized environmental notification messages at periodic intervals until the distance exceeds a threshold distance from the traffic perturbation: and transmit the subsequent decentralized environmental notification messages to the roadside communication device.

Example 53 is at least one non-transitory machine-readable medium including instructions for traffic perturbation mitigation that, when executed by the at least one processor, cause the at least one processor to perform operations to: detect a traffic perturbation based on an evaluation of sensor data obtained from sensors of a vehicle; generate a decentralized environmental notification message based on the detected traffic perturbation; transmit the decentralized environmental notification message to a roadside communication device: receive a maneuver coordination message from the roadside communication device: and execute a maneuver of the vehicle based on the maneuver coordination message.

In Example 54, the subject matter of Example 53 includes, instructions that, when executed by the at least one processor, cause the at least one processor to perform operations to: determine that the roadside communication device is not available; and transmit the decentralized environmental notification message to a second vehicle.

In Example 55, the subject matter of Examples 53-54 includes, instructions that, when executed by the at least one processor, cause the at least one processor to perform operations to: receive a decentralized environmental notification message from a second vehicle; generate a mitigation instruction based on the decentralized environmental notification message from the second vehicle; and execute the maneuver of the vehicle based on the mitigation instruction.

In Example 56, the subject matter of Example 55 includes, instructions that, when executed by the at least one processor, cause the at least one processor to perform operations to: reconfigure safety driving model parameters of the vehicle based on the mitigation instruction.

In Example 57, the subject matter of Examples 53-56 includes, instructions that, when executed by the at least one processor, cause the at least one processor to perform operations to: generate subsequent decentralized environmental notification messages at periodic intervals until expiration of a time window associated with the traffic perturbation; and transmit the subsequent decentralized environmental notification messages to the roadside communication device.

In Example 58, the subject matter of Example 57 wherein the periodic intervals are determined based on the traffic perturbation.

In Example 59, the subject matter of Examples 53-58 includes, instructions that, when executed by the at least one processor, cause the at least one processor to perform operations to: reconfigure safety driving model parameters of the vehicle based on the maneuver coordination message.

In Example 60, the subject matter of Examples 53-59 includes, instructions that, when executed by the at least one processor, cause the at least one processor to perform operations to: determine a distance of the vehicle from a location of the traffic perturbation; generate subsequent decentralized environmental notification messages at periodic intervals until the distance exceeds a threshold distance from the traffic perturbation; and transmit the subsequent decentralized environmental notification messages to the roadside communication device.

Example 61 is a method for traffic perturbation mitigation comprising: detecting a traffic perturbation based on an evaluation of sensor data obtained from sensors of a vehicle; generating a decentralized environmental notification message based on the detected traffic perturbation; transmitting the decentralized environmental notification message to a roadside communication device: receiving a maneuver coordination message from the roadside communication device; and executing a maneuver of the vehicle based on the maneuver coordination message.

In Example 62, the subject matter of Example 61 includes, determining that the roadside communication device is not available; and transmitting the decentralized environmental notification message to a second vehicle.

In Example 63, the subject matter of Examples 61-62 includes, receiving a decentralized environmental notification message from a second vehicle: generating a mitigation instruction based on the decentralized environmental notification message from the second vehicle; and executing the maneuver of the vehicle based on the mitigation instruction.

In Example 64, the subject matter of Example 63 includes, reconfiguring safety driving model parameters of the vehicle based on the mitigation instruction.

In Example 65, the subject matter of Examples 61-64 includes, generating subsequent decentralized environmental notification messages at periodic intervals until expiration of a time window associated with the traffic perturbation; and transmitting the subsequent decentralized environmental notification messages to the roadside communication device.

In Example 66, the subject matter of Example 65 wherein the periodic intervals are determined based on the traffic perturbation.

In Example 67, the subject matter of Examples 61-66 includes, reconfiguring safety driving model parameters of the vehicle based on the maneuver coordination message.

In Example 68, the subject matter of Examples 61-67 includes, determining a distance of the vehicle from a location of the traffic perturbation; generating subsequent decentralized environmental notification messages at periodic intervals until the distance exceeds a threshold distance from the traffic perturbation; and transmitting the subsequent decentralized environmental notification messages to the roadside communication device.

Example 69 is at least one machine-readable medium including instructions that, when executed by a machine, cause the machine to perform any method of Examples 61-68.

Example 70 is a system comprising means to perform any method of Examples 61-68.

Example 71 is at least one machine-readable medium including instructions that, when executed by processing circuitry, cause the processing circuitry to perform operations to implement of any of Examples 1-70.

Example 72 is an apparatus comprising means to implement of any of Examples 1-70.

Example 73 is a system to implement of any of Examples 1-70.

Example 74 is a method to implement of any of Examples 1-70.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for traffic perturbation detection comprising:
at least one processor; and
memory including instructions that, when executed by the at least one processor, cause the at least one processor to perform operations to:
obtain sensor data for a segment of a roadway and vehicle communication data for vehicles travelling on the segment;
calculate a vehicle density for the segment using the sensor data and the vehicle communication data;
based on the calculated vehicle density, monitor the sensor data and the vehicle communication data for a traffic perturbation;
upon detection of the traffic perturbation, select a mitigation instruction for the traffic perturbation; and
transmit the mitigation instruction to a vehicle or group of vehicles traveling on the roadway.

2. The system of claim 1, wherein the vehicle communication data is obtained from a roadside communication device in proximity of the segment of the roadway.

3. The system of claim 1, the instructions to detect the traffic perturbation further comprising instructions that, when executed by the at least one processor, cause the at least one processor to perform operations to:
obtain vehicle density values for a spatial window calculated from the sensor data; and
identify a spike in the vehicle density above a threshold as the traffic perturbation.

4. The system of claim 1, the instructions to detect the traffic perturbation further comprising instructions that, when executed by the at least one processor, cause the at least one processor to perform operations to:
obtain decentralized environmental notification messages from vehicles traveling along the segment of the roadway; and
determine characteristics of the perturbation based on an evaluation of at least one of a location, a velocity, a deceleration rate, and a detection confidence level included in the decentralized environmental notification messages, wherein selection of the mitigation is based on the characteristics of the perturbation.

5. The system of claim 1, the memory further comprising instructions that, when executed by the at least one processor, cause the at least one processor to perform operations to:
determine a mitigation plan for avoiding a phantom traffic jam based on the perturbation by evaluating detection information associated with the perturbation; and
generate a driving advisory based on the mitigation plan, wherein the driving advisory is transmitted as the mitigation instruction.

6. The system of claim 5, the memory further comprising instructions that, when executed by the at least one processor, cause the at least one processor to perform operations to determine a type for the vehicle or the group of vehicles, wherein the driving advisory is generated in part based on the determined type.

7. The system of claim 5, the memory further comprising instructions that, when executed by the at least one processor, cause the at least one processor to perform operations to determine an operating lane for the vehicle or the group of vehicles, wherein the driving advisory is generated in part based on the determined operating lane.

8. The system of claim 5, the memory further comprising instructions that, when executed by the at least one processor, cause the at least one processor to perform operations to determine a roadway segment for the vehicle or the group of vehicles, wherein the driving advisory is generated in part based on the determined roadway segment.

9. The system of claim 5, the memory further comprising instructions that, when executed by the at least one processor, cause the at least one processor to perform operations to:
generate a maneuver coordination message using the driving advisory; and
transmit the maneuver coordination message to a vehicle or a group of vehicles operating on the segment of the roadway.

10. The system of claim 9, the memory further comprising instructions that, when executed by the at least one processor, cause the at least one processor to perform operations to forward the maneuver coordination message to a multi-access edge computing node on a second segment of the roadway for delivery to a vehicle operating on the second segment of the roadway via a roadside communication device in proximity of the second segment of the roadway.

11. At least one non-transitory machine-readable medium including instructions for traffic perturbation detection that, when executed by at least one processor, cause the at least one processor to perform operations to:
obtain sensor data for a segment of a roadway and vehicle communication data for vehicles travelling on the segment;
calculate a vehicle density for the segment using the sensor data and the vehicle communication data;
based on the calculated vehicle density, monitor the sensor data and the vehicle communication data for a traffic perturbation;
upon detection of the traffic perturbation, select a mitigation instruction for the traffic perturbation; and
transmit the mitigation instruction to a vehicle or group of vehicles traveling on the roadway.

12. The at least one non-transitory machine-readable medium of claim 11, the instructions to detect the traffic perturbation further comprising instructions that, when executed by the at least one processor, cause the at least one processor to perform operations to:
obtain vehicle density values for a spatial window calculated from the sensor data; and
identify a spike in the vehicle density above a threshold as the traffic perturbation.

13. The at least one non-transitory machine-readable medium of claim 11, the instructions to detect the traffic perturbation further comprising instructions that, when executed by the at least one processor, cause the at least one processor to perform operations to:
obtain decentralized environmental notification messages from vehicles traveling along the segment of the roadway; and
determine characteristics of the perturbation based on an evaluation of at least one of a location, a velocity, a deceleration rate, and a detection confidence level included in the decentralized environmental notification messages, wherein selection of the mitigation is based on the characteristics of the perturbation.

14. The at least one non-transitory machine-readable medium of claim 11, further comprising instructions that, when executed by the at least one processor, cause the at least one processor to perform operations to:
determine a mitigation plan for avoiding a phantom traffic jam based on the perturbation by evaluating detection information associated with the perturbation; and
generate a driving advisory based on the mitigation plan, wherein the driving advisory is transmitted as the mitigation instruction.

15. The at least one non-transitory machine-readable medium of claim 14, further comprising instructions that, when executed by the at least one processor, cause the at least one processor to perform operations to:
generate a maneuver coordination message using the driving advisory; and
transmit the maneuver coordination message to a vehicle or a group of vehicles operating on the segment of the roadway.

16. The at least one non-transitory machine-readable medium of claim 15, wherein the maneuver coordination message includes a maneuver coordination container and further comprising instructions that, when executed by the at least one processor, cause the at least one processor to perform operations to:
transmit information between a first roadside communication device and a second roadside communication device using the maneuver coordination container.

17. A system for traffic perturbation mitigation comprising:
at least one processor; and
memory including instructions that, when executed by the at least one processor, cause the at least one processor to perform operations to:
detect a traffic perturbation based on an evaluation of sensor data obtained from sensors of a vehicle;
generate a decentralized environmental notification message based on the detected traffic perturbation;
transmit the decentralized environmental notification message to a roadside communication device;
receive a maneuver coordination message from the roadside communication device; and
execute a maneuver of the vehicle based on the maneuver coordination message.

18. The system of claim 17, the memory further comprising instructions that, when executed by the at least one processor, cause the at least one processor to perform operations to:
determine that the roadside communication device is not available; and
transmit the decentralized environmental notification message to a second vehicle.

19. The system of claim 17, the memory further comprising instructions that, when executed by the at least one processor, cause the at least one processor to perform operations to:
receive a decentralized environmental notification message from a second vehicle;
generate a mitigation instruction based on the decentralized environmental notification message from the second vehicle; and
execute the maneuver of the vehicle based on the mitigation instruction.

20. The system of claim 19, the memory further comprising instructions that, when executed by the at least one processor, cause the at least one processor to perform operations to:
reconfigure safety driving model parameters of the vehicle based on the mitigation instruction.

21. The system of claim 17, the memory further comprising instructions that, when executed by the at least one processor, cause the at least one processor to perform operations to:
generate subsequent decentralized environmental notification messages at periodic intervals until expiration of a time window associated with the traffic perturbation; and
transmit the subsequent decentralized environmental notification messages to the roadside communication device.

22. The system of claim 21, wherein the periodic intervals are determined based on the traffic perturbation.

23. The system of claim 17, the memory further comprising instructions that, when executed by the at least one processor, cause the at least one processor to perform operations to:
reconfigure safety driving model parameters of the vehicle based on the maneuver coordination message.

24. The system of claim 17, the memory further comprising instructions that, when executed by the at least one processor, cause the at least one processor to perform operations to:
determine a distance of the vehicle from a location of the traffic perturbation;
generate subsequent decentralized environmental notification messages at periodic intervals until the distance exceeds a threshold distance from the traffic perturbation; and
transmit the subsequent decentralized environmental notification messages to the roadside communication device.
